(19) United States
(12) Patent Application Publication
(10) Pub. No.: US 2007/0038455 A1
(43) Pub. Date: Feb. 15, 2007

(54) Accent detection and correction system

(76) Inventors: Marina V. Murzina, Carlsbad, CA (US); Alan L. Prouse, Murrieta, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 11/200,265

(22) Filed: Aug. 9, 2005

(51) Int. Cl. G10L 13/00

(52) U.S. Cl. 704/263

(57) ABSTRACT

A concept, method and apparatus for detecting and correcting an accent by means of sound morphing is provided. The input audio signal is analyzed for finding pre-specified unwanted speech patterns, i.e. phonemes or groups of phonemes that are to be corrected, for instance because they represent a foreign accent. These unwanted sounds are then modified or completely replaced by the pre-stored replacement audio patterns, adjusted to the current pitch and voice timbre of the user. The degree of speech modification, i.e. the set of phonemes to be modified, can be set at a desired level. The system works in two modes: first, learning, i.e. storing the unwanted and the replacement phoneme patterns, and second, the correction mode which performs phoneme modification based on the stored information. The implementation is both in software and hardware. The hardware apparatus is based on parallel signal processing and therefore allows for real-time accent correcting of variable complexity, up to multiple-user multiple-accent super-complex systems based on mesh architecture of multiple chips and boards, possibly as a part of a telephone or another networking system.

### FIELD OF THE INVENTION

The present invention relates to a new and improved accent detection and correction system. More particularly, the present invention relates to an apparatus which analyzes input audio signals for pre-specified phonemes or generally, combinations of sounds (for example, stuttering episodes), that are to be corrected. These sounds are modified or replaced by pre-stored audio patterns adjusted to current user pitch and voice timbre. The device works in two modes. The learning mode stores the sound-combinations to be corrected or replaced and the phoneme or sound patterns to be used to replace the corrected sounds. The correction mode then modifies phonemes based on the stored information (the main mode). The hardware specified by the current invention is based on parallel signal processing and allows for real-time accent correcting of variable complexity, up to multiple-user, multiple accents, super-complex systems based on mesh architecture of multiple chips and boards, possibly as a part of a telephone or another networking system.

### BACKGROUND OF THE INVENTION

Commonly utilized speech patterns are distinguishable by distinctive foreign and domestic accents. In what follows, the word “accent” means “speech pattern.” Often these speech patterns are marked by phonemes, syllables or generally, sound combinations which are irritating or difficult to understand. These sounds disrupt or slow down the communication and often affect commerce and other daily transactions. Automatic correction of speech sounds would facilitate communication and could prevent lost time, misunderstandings and aggravation that are a result of difficulties in transmitting communications. It can also increase self-esteem of a speaking person, especially in the situations of delivering a speech to a large auditorium.

The present invention may also be utilized as a teaching device. The accent detection and correction system may be used to indicate when the pre-chosen unwanted sound patterns occur in actual speech. The accent detection and correction system may also be used for quantitatively comparing speech patterns of different groups of people, different individuals, or the same person at different times, by explicating the sound patterns that are to be corrected and the degree of their deviation from the “correct” ones.

The method can be used for identifying a speaking person's accent, since the accent detection and correction system can compare the input speech to a set of target accents and evaluate the closest match (least number of corrections to be made).

The benefits of inventions for correction of speech anomalies are well known. Examples of different types and kinds of inventions for modulation of various aspects of speech are disclosed in U.S. Pat. Nos. 6,591,240 B1, 6,336,090 B1, 5,847,303, 5,559,792, and 4,241,235.

The invention described in U.S. Pat. No. 6,591,240 B1 addresses the issue of how to concatenate messages recorded with different voices so as to avoid abrupt, unpleasant changes. A gradual change of certain parameter(s) of speech in a transition segment is provided by this novel invention. As a choice of this parameter, the suggested fundamental frequency is the pitch. However, the problem of modifying the phonemes characteristic of various speech patterns or accents is not addressed.

Therefore, it would be highly desirable to have a new and improved invention which would not only modulate pitch but address the modulation of problematic phonemes which are characteristic of troublesome accents.

The novel invention disclosed in U.S. Pat. No. 6,336,090 B1 addresses the problem of sending wireless signals along with certain features of the voice input. Those features must be extracted by a handset and help to preserve the communication in the presence of noise. This novel invention addresses the problem of preserving individual characteristics, however, does not address the particular goal of considering and changing accent-related individual characteristics.

Therefore, it would be highly desirable to have a new and improved invention which would have a very specific goal of considering accent-related particular individual characteristics, and changing, not preserving them thus to addressing the problem of correction of accent related phonemes.

U.S. Pat. No. 5,847,303 retains formant frequencies while changing pitch so that karaoke singers can easily tune to the sample voice of the original singer. The invention does not address the problem of recognition accent related phonemes or correction of those anomalies.

Therefore it would be highly desirable to have an invention which would be able to address both pitch and format frequencies in order to adapt speech patterns to a more familiar or standard set of values for acceptable speech formats.

Similarly, U.S. Pat. No. 5,559,792 describes an invention that includes voice modifications and a fixed and time varying voice signal by means of well-known sound effects. The novel invention modifies the sound of the voice or adds noise. Again, the pitch is the primary portion of the sound of the voice which is the value being modified. The invention does speak to the issue of varying the content of the speech, but does vary the pitch of the voice.

Therefore it would be highly desirable to vary the content, not simply time varying, signal modification at formant frequencies (low frequencies that determine phonemes), in addition to the pitch frequencies (high frequencies that determine how “low” your voice is).

The invention described in U.S. Pat. No. 4,241,235 modulates voices with high-frequency signals (adding higher frequency to certain bands of signal frequencies). Basically, this invention modifies pitch characteristics while preserving phoneme-forming features of speech.

Therefore it would be highly desirable to have an invention which would not only address modification of pitch but would instead also change the phoneme content (i.e. at frequencies not much different from the original ones), and said changes would be content-dependent.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF THE INVENTION

The principle object of this invention is to enable a user to modify incoming user speech patterns using pre-specified speech pattern information.

A further object of this invention is to enable the user to pre-specify any unwanted phoneme, or generally, any unwanted speech-sound patterns.

Yet another object of this invention is to enable the user to modify the incoming user speech using the pre-specified corresponding desired (wanted) replacement speech patterns.

A particular object of this invention is to enable the user to modify pitch as well as phonemes, or groups of sounds, in speech patterns.

The preferred embodiment of the present invention provides a system which functions in two modes. The first mode is the learning mode and the second mode is the correction mode. The object of the invention is to enable a user to correct his/her speech patterns, or accent, by pre-specifying the unwanted phoneme patterns to be replaced, as well as the corresponding desired replacement patterns, and then modifying the incoming user speech using the pre-specified information.

This novel invention incorporates a learning mode wherein the user records the unwanted phoneme patterns that are stored in the memory of the device. The user also records the desired patterns for replacement. The desired patterns can be produced by the user him/her-self or by another speaker and then modified in pitch and timbre to match the desired speech pattern.

The present invention receives the input in the form of digital signal extracted from the sound (speech) signal by a microphone-type device. As the digital sound signal comes into the accent detection and correction system, the device recognizes the unwanted sound patterns by comparing the signal with the pre-stored library of unwanted phonemes or sound groups. For each unwanted group of sounds, the accent corrector finds the corresponding desired digital signal from the pre-stored library of the replacement phoneme groups.

The accent detection and correction system adjusts the replacement sound signal to match the current pitch and possibly the timbre of the speaker and fits the adjusted speech fragment into the speech stream to substitute the unwanted sound pattern.

The resulting corrected sound stream is then sent out (output) to a receiver such as speakers or a telephone.

A first alternate embodiment of the current invention may be utilized for real-time accent correction of variable complexity, possibly as part of a telephone or another networking system.

A second alternate embodiment of the accent detection and correction system may be used as a teaching device indicating pre-chosen unwanted sound patterns occurring in actual speech and suggesting replacement phonemes in order to correct language pronunciation.

A third alternate embodiment of the accent detection and correction system may be used to detect and identify a speaking person's accent by comparing the input speech to a set of target accents and evaluating the closest match with the least number of corrections to be made.

It must be clearly understood at this time although the preferred embodiment of the invention consists of the accent detection and correction system means, that many conventional audio input, audio output, CPU and memory devices exist, including microprocessors, microchips, Random Access Memory (RAM), various media for storage and sorting of desired data, or combinations thereof, that will achieve the a similar operation and they will also be fully covered within the scope of this patent.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1A is a block diagram representing step 1, depicting the recording and storing of unwanted speech patterns in the learning mode, constructed in accordance with the present invention;

FIG. 1B depicts a waveform pattern for the word “parade” and illustrates step 1, recording and storing the unwanted speech patterns, constructed in accordance with the present invention;

FIG. 1C depicts a fragment of the waveform shown in FIG. 1B for the portion of the word “parade” that is “aRa” further illustrating step 1, recording and storing the unwanted speech patterns, constructed in accordance with the present invention;

FIG. 1D depicts a signal pattern of the unwanted sound where the unwanted sound extracted data is analyzed and stored in the unwanted sounds database;

FIG. 2A is a block diagram representing step 2, depicting the recording and storing of replacement speech patterns, constructed in accordance with the present invention;

FIG. 2B depicts a waveform pattern for the word “parade” and illustrates step 2, Recording and storing the replacement speech patterns, constructed in accordance with the present invention;

FIG. 2C depicts a fragment of the waveform shown in FIG. 2B for the portion of the word “parade” that is “ara” further illustrating step 2, the recording and storing the replacement speech patterns, constructed in accordance with the present invention;

FIG. 2D depicts a signal pattern of the unwanted sound where the replacement sound extracted data is analyzed and stored in the replacement sounds database;

FIG. 3 is a block diagram representing step 3, depicting the recording and modifying of speech patterns, constructed in accordance with the present invention;

FIG. 4 depicts a waveform pattern for the word “parade” and illustrates step 4, correction mode testing for training, testing and calibrating the system, constructed in accordance with the present invention;

FIG. 5A is a block diagram representing step 4, depicting the function data flow in the correction mode, constructed in accordance with the present invention;

FIG. 5B depicts a waveform pattern for the word “correct” and illustrates the correction of a new word with a similar pattern in which the system has been previously trained, constructed in accordance with the present invention;

FIG. 5C depicts a fragment of the waveform shown in FIG. 5B for the portion of the word “correct” that is “oRRe” further illustrating how the system uses incoming speech sound data to compare to the library of patterns of unwanted sounds, constructed in accordance with the present invention;

FIG. 5D depicts a waveform pattern for the word “correct” and illustrates how in the correction mode the system adjusts for pitch and volume and fit into an incoming signal to replace the unwanted pattern, constructed in accordance with the present invention;

FIG. 5E depicts a waveform pattern for the word “correct” and illustrates in the correction mode how the desired audio signal fits to replace the unwanted sound pattern, constructed in accordance with the present invention; and

FIG. 6 is a block diagram representing the construction of the system from input sound signals to output sound signals and the analysis, comparison to libraries and characterization of speech patterns, constructed in accordance with the present invention.

For a fuller understanding of the nature and objects of the invention, reference should be had to the following detailed description taken in conjunction with the accompanying drawings which are incorporated in and form a part of this specification, illustrate embodiments of the invention and together with the description, serve to explain the principles of this invention.

### DETAILED DESCRIPTION OF THE PREFERRED EMBODIMENTS

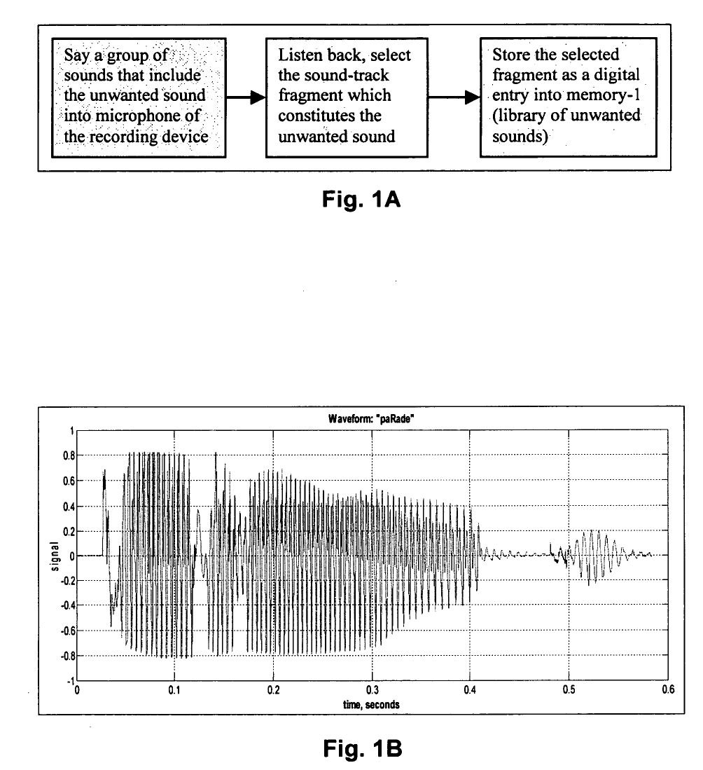

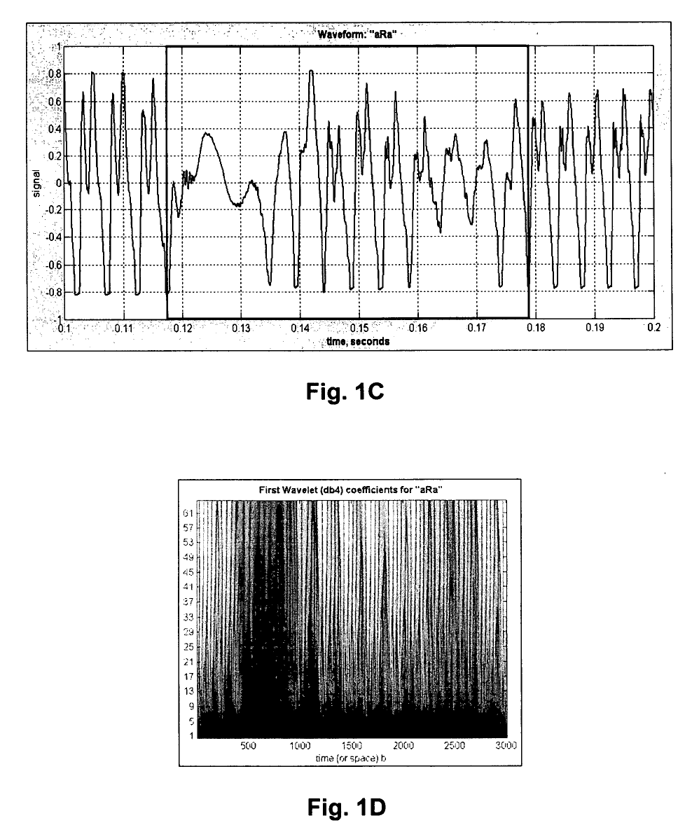

For a fuller understanding of the nature and objects of the invention, reference should be had to the following detailed description taken in conjunction with the accompanying drawings wherein similar parts of the invention are identified by like reference numerals. There is seen in FIG. 1 a block diagram representation of step 1, the learning mode of the accent detection and correction system, illustrating the recording and storing of unwanted speech patterns. For each unwanted sound, the user verbalizes a group of sounds which include the unwanted sound into the microphone of the recording device. The unwanted sounds are selected from the sound-track fragment and then stored as a digital entry into memory-1. This memory-1 represents the library of unwanted sounds.

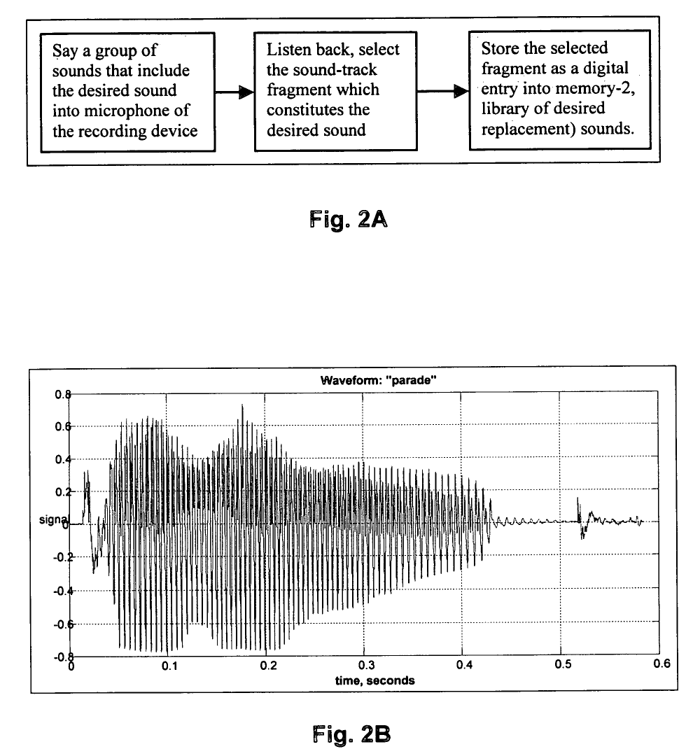

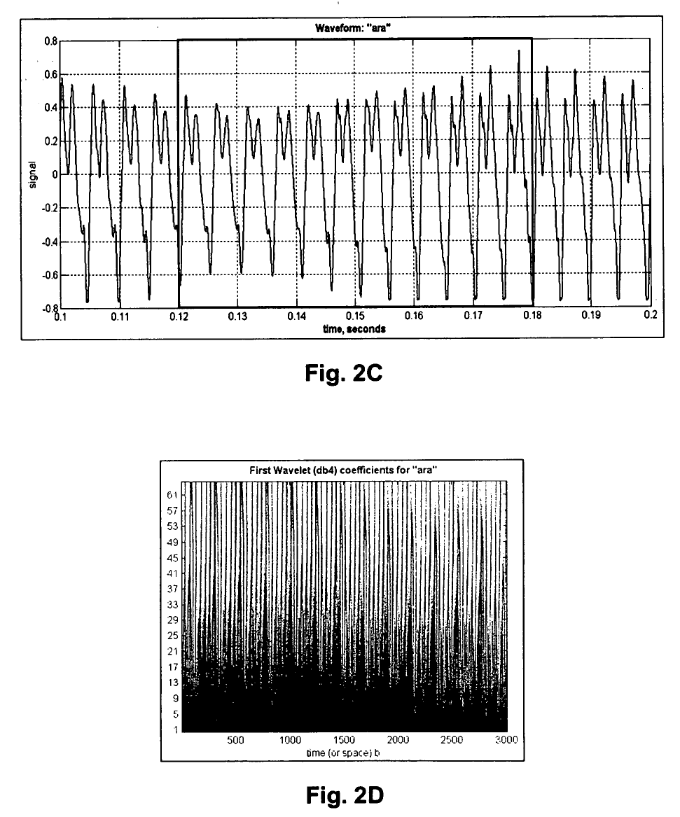

The operation of step 1 of the present accent detection and correction system is illustrated in FIGS. 1B-1D by showing the waveforms and patterns of the word containing the unwanted sound, in this example the unwanted sound is a rolling “R” found in the word “parade.” In principle, the operation of choosing the unwanted sound does not require visually displaying the waveform. Alternatively, it can be done by selecting start and end points of the sound stream and listening to the resulting fragment. At the same time, the waveform-display feature could be helpful, especially in a high-end application. As an illustration of the pattern-recognition technique, see FIG. 2D below, which presents the wavelet coefficients.

FIG. 2A is a block diagram representation of step 2: the learning mode of the accent detection and correction system. This step is the recording (or acquiring) and storing of the replacement speech patterns. For each replacement sound corresponding to the unwanted sound described above, the desired patterns for replacement are generated by the user. The user verbalizes a group of sounds that include the desired sound into the microphone of the recording device. The listen back selects the sound track fragment with the segment that constitutes the replacement sound. The selected fragment is stored as a digital entry into memory-2 (library of replacement sounds). This operation is illustrated in FIGS. 2B-2D by showing the waveforms and patterns of the word containing the replacement sound, in this example, an American or non-rolling “r” in the word “parade.”

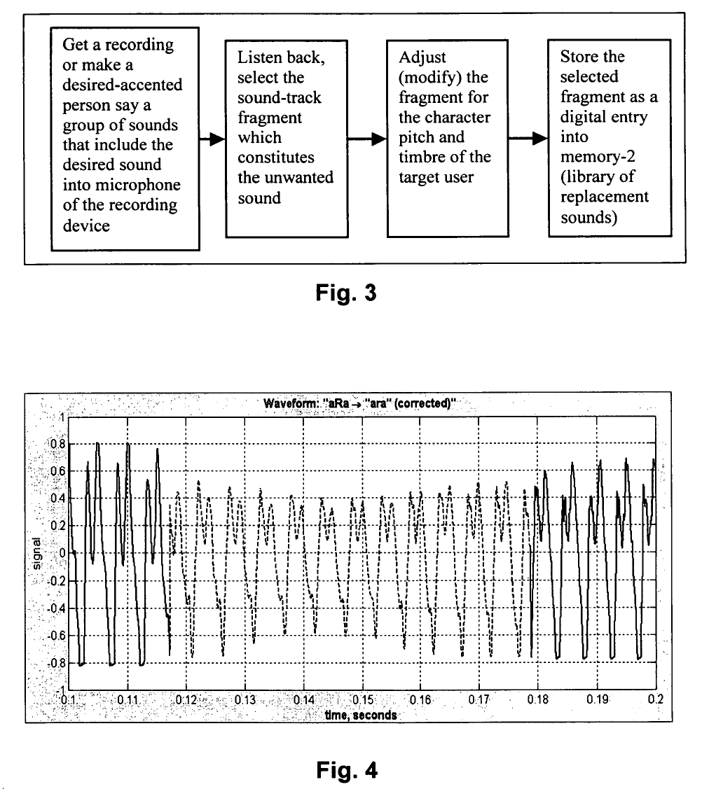

An alternative source of replacement sounds is illustrated in FIG. 3. The desired patterns can be produced by recording speech patterns from another speaker and modifying the pitch and timbre to match the pitch and timbre of that of the user. The source person speaks into the microphone. The listen back selects the sound-track fragment which constitutes the desired sound. The pitch and timbre is then modified to correspond to the characteristic pitch and timbre of the target user. The selected fragment is then stored in memory-2 (a library of replacement sounds) as a digital entry.

In step 3, single replacement testing is performed. This is an optional stage but it could be advantageous. For this test, we technically use the device in a simplified version of the correction mode. The device looks only for the one sound specified in step 1 and replaces it with one sound specified in step 2. The operation is illustrated in FIG. 4 which shows the waveform of the word “paRade”, from the step 1 example, with rolling-“R” replaced by the desired American “r” from the word “parade” of the step 2 example.

In the simplest version, the user verbalizes different words that contain the specified unwanted sound and checks to determine if the replacement has been made and how it sounds. The fact of replacement is indicated by a signal. The original and the resulting (modified) words are stored into an additional buffer memory and can be played back. In terms of penalty-values, (see below), the simple version has to use the conservative (high) threshold for all sounds. The goal is to not allow undesired substitutions. At the same time, if actual sound deviates too much from the target unwanted sound from step 1 and is not substituted, the user has to set up an additional entry for this sound. The same replacement sound can be re-used for different unwanted sounds.

In a more advanced version, this test can be used to set up the threshold “penalty value.” Deviation between an actual arbitrary sound and the specified unwanted sound, such that if the deviation (penalty) is smaller than the threshold, the actual sound will be considered to coincide with the specified unwanted sound, and replaced. In a penalty-adjustment mode, the user can change the penalty value while saying the words containing the unwanted sound. If the user tries too high a penalty, no replacement is made which will be seen from the signal. As the penalty is made lower by the user, the unwanted sound gets replaced (and both the original and the resulting words can be played back). When the penalty is too low, multiple sounds will be recognized as the unwanted pattern and replaced. This will be seen from multiple replacement indications and from the results of recording. So the user can try different words and select the optimal penalty threshold for the given sound. The device can store a few penalty thresholds for each sound, to provide with a few levels of correction.

In step 4, general testing can be performed. This stage is also optional and can be very useful. Here, the device is used in a fully functioning correction mode (i.e. searched for all unwanted sounds stored so far) plus fragments of speech can be recorded, both in their original and the device-modified versions. Here, the user can further correct the penalty values so that to not confuse the sounds.

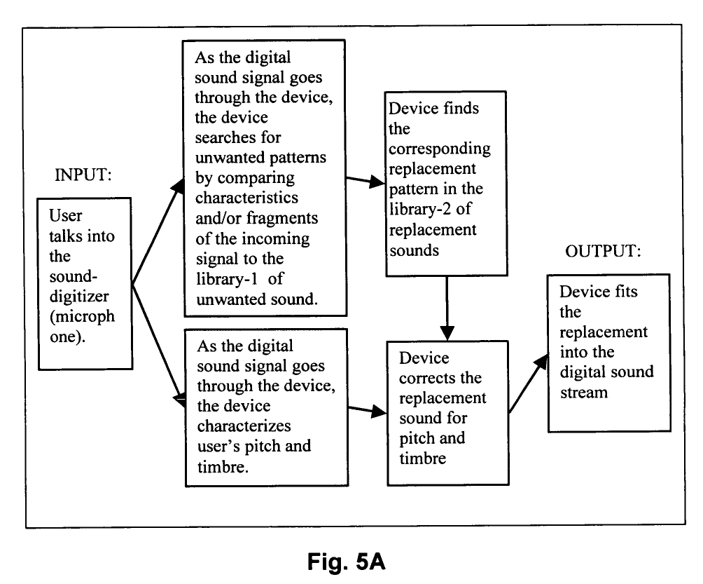

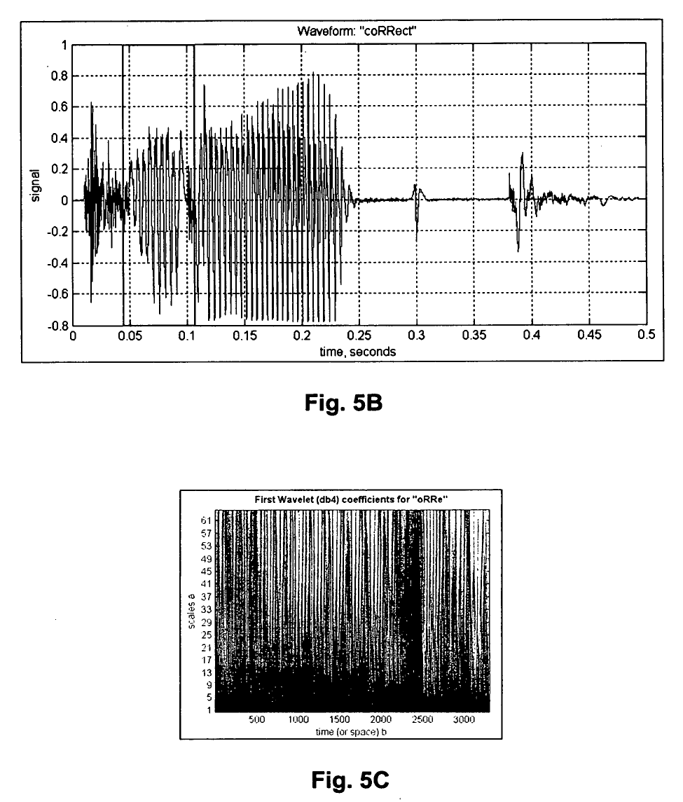

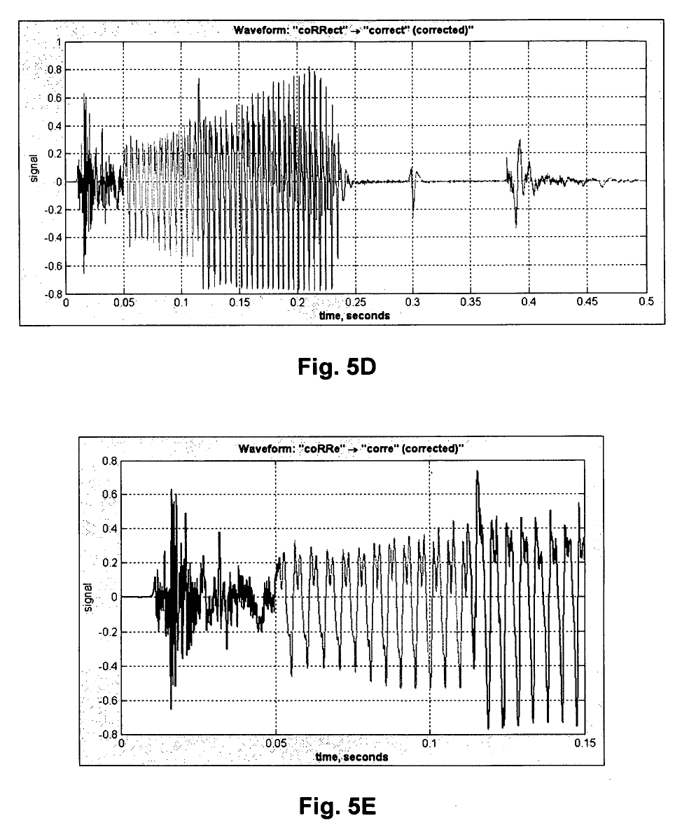

FIG. 5A depicts the correction mode of the accent corrector. The accent detection and correction system takes the input in the form of digital signal extracted from the sound speech signal by a microphone-type device.

As the digital sound signal comes into the accent detection and correction system, the device recognizes the unwanted patterns of phonemes by comparing the signal with the pre-stored library of unwanted phonemes. For each unwanted group of sounds, the accent corrector finds the corresponding “desired” digital signal from the pre-stored library of the replacement phoneme groups. The device adjusts the replacement sound signal to match the current pitch and possibly the timbre of the speaker and fits the adjusted speech fragment into the speech stream to substitute the unwanted pattern.

The resulting corrected sound stream is then sent out (output) to its destination, a receiver such as a telephone or speakers. The operation is illustrated in FIGS. 5B-5E which follow the process of identifying the unwanted sound (rolling “R”) in an incoming speech signal (using the pattern-recognition technique) and replacing it with the desired sound pattern. FIG. 5B illustrates the waveform of the word “coRRect” (with wrong rolling “R”) which is a new work: it has not been used as an example for training the system. The rolling “R” is identified using the pattern-recognition techniques which are illustrated by framing it in the waveform.

FIG. 5C depicts details of recognizing the unwanted sound. The signal pattern of the incoming speech sound is analyzed and the extracted information about this pattern is compared against the library of patterns of unwanted signals. Here we illustrate this operation by calculating and displaying the wavelet coefficients (their values are shown as brightness level) of the rolling-R fragment of the incoming word “correct”. Wavelets illustrate one of the pattern recognition techniques. As a result of comparison with the “unwanted-signal” library (like FIG. 1D), the rolling “R” is identified as an unwanted sound signal.

In FIG. 5D, the correction mode, example 2, the desired sound pattern corresponding to the identified unwanted sound pattern is adjusted for pitch and volume and fit into the incoming signal to replace the unwanted pattern. Here we illustrate this operation by fitting the good “r” stored in step 2 (see FIGS. 2A-2D) into the incoming word “coRRect”. The waveform of the formed word contains the green insertion fragment with the desired sound from the library.

In the correction mode, example 2, a fragment of FIG. 5D shows how the desired audio signal fits to replace the unwanted sound pattern.

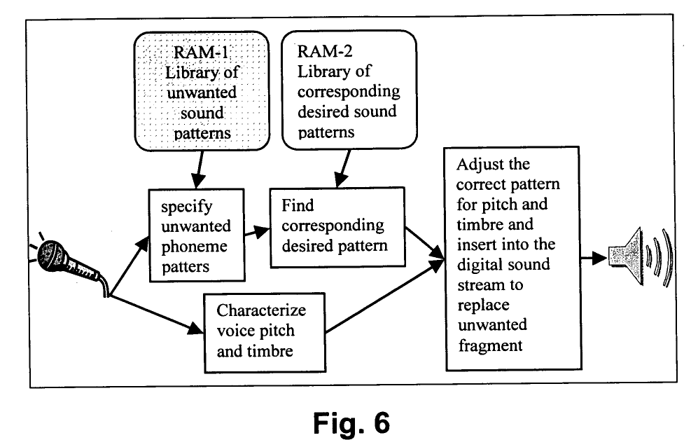

FIG. 6 depicts the construction of the accent detection and correction system in a block diagram. The accent corrector can be used a stand-alone device or inside of a sound-streaming system such as a telephone. The accent corrector has an input port from a microphone, the first memory (memory-1 or RAM1) which stores the unwanted speech signals, the second memory (memory-2 or RAM2) which stores the desired replacement signals, the central chip(s) that performs the replacement and the output port which sends the corrected signal out.

In operation, the user can have the device always turned on (especially if it is a part of a larger device) or will have to turn the device on to use it. The device can be powered from a battery or an electrical plug or solar or other energy source.

In the learning mode, the user would have to perform the steps described in the learning mode and the correction mode. If the device includes all modes in one physical implementation, the user will operate a special series of controls to indicate the learning regime itself as well as its steps, and playback operations.

In the correction mode, the user uses a penalty-level control to specify how tight or loose the search for unwanted patterns is to be and then leaves the device to perform correction. As an option, the user can listen to the output of his/her corrected speech through an additional earphone or another sound-generating device.

The accent detection and correction system shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed for providing an accent detection and correction system in accordance with the spirit of this invention, and such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

We claim:

1. An accent detection and correction system comprising:
(a) means for inputting unwanted speech patterns such that said speech patterns are digitalized, analyzed and stored in a digital memory library of unwanted speech patterns;
(b) means for inputting desired speech patterns corresponding to said unwanted speech patterns such that said desired speech patterns are digitalized, analyzed and stored in a digital memory library of desired speech patterns;
(c) means for actively detecting incoming speech patterns, comparing said detected incoming speech patterns with said unwanted speech patterns stored in said digital memory of unwanted speech patterns such that the unwanted speech patterns found in said incoming speech patterns are removed and queued for replacement;
(d) means for analyzing said unwanted speech patterns in incoming speech patterns and determining positively corresponding desired speech patterns; and
(e) means for replacing said unwanted speech patterns found in said incoming speech patterns with said desired speech patterns which are determined to be positively corresponding to said unwanted speech patterns,
thereby producing an output speech pattern in which said unwanted speech patterns have been removed and replaced with said desired speech patterns.

2. The accent detection and correction system according to claim 1, wherein said means for inputting unwanted and desired speech patterns includes inputting speech patterns via a conventional microphone.

3. The accent detection and correction system according to claim 2, wherein said microphone inputted speech patterns are digitalized using a computer.

4. The accent detection and correction system according to claim 1, wherein said inputted unwanted and desired speech patterns are stored in one or more digital memory libraries.

5. The accent detection and correction system according to claim 1, wherein said means for actively detecting incoming speech patterns, comparing said detected incoming speech patterns with said unwanted speech patterns stored in said digital memory of unwanted speech patterns such that the unwanted speech patterns found in said incoming speech patterns are removed and queued for replacement, includes actively detecting incoming speech patterns, comparing said detected incoming speech patterns with said unwanted speech patterns stored in said digital memory of unwanted speech patterns such that the unwanted speech patterns found in said incoming speech patterns are removed and queued for replacement in real time.

6. The accent detection and correction system according to claim 1, wherein said means for analyzing said unwanted speech patterns in incoming speech patterns and determining positively corresponding desired speech patterns includes analyzing said unwanted speech patterns in incoming speech patterns and determining positively corresponding desired speech patterns in real time.

7. The accent detection and correction system according to claim 1, wherein said means for replacing said unwanted speech patterns found in said incoming speech patterns with said desired speech patterns which are determined to be positively corresponding to said unwanted speech patterns includes replacing said unwanted speech patterns found in said incoming speech patterns with said desired speech patterns which are determined to be positively corresponding to said unwanted speech patterns in real time, thereby producing an output speech pattern in which said unwanted speech patterns have been removed and replaced with said desired speech patterns.

8. The accent detection and correction system according to claim 1, wherein said system is used for teaching desired speech patterns by modifying inputted unwanted speech patterns and outputting desired speech patterns in real time.

9. The accent detection and correction system according to claim 1, wherein said system is used to analyze unwanted speech patterns to detect languages, dialects and accents.

10. The accent detection and correction system according to claim 1, wherein said system is used to analyze desired speech patterns to detect languages, dialects and accents.

11. A method for modifying speech patterns, comprising the steps of:
(a) inputting unwanted speech patterns such that said speech patterns are digitalized, analyzed and stored in a digital memory library of unwanted speech patterns;
(b) inputting desired speech patterns corresponding to said unwanted speech patterns such that said desired speech patterns are digitalized, analyzed and stored in a digital memory library of desired speech patterns;
(c) actively detecting incoming speech patterns, comparing said detected incoming speech patterns with said unwanted speech patterns stored in said digital memory of unwanted speech patterns such that the unwanted speech patterns found in said incoming speech patterns are removed and queued for replacement;
(d) analyzing said unwanted speech patterns in incoming speech patterns and determining positively corresponding desired speech patterns; and
(e) replacing said unwanted speech patterns found in said incoming speech patterns with said desired speech patterns which are determined to be positively corresponding to said unwanted speech patterns,
thereby producing an output speech pattern in which said unwanted speech patterns have been removed and replaced with said desired speech patterns.

12. The method for modifying speech patterns according to claim 11, wherein said step of inputting unwanted and desired speech patterns includes inputting speech patterns via a conventional microphone.

13. The method for modifying speech patterns according to claim 12, wherein said microphone inputted speech patterns are digitalized using a computer.

14. The method for modifying speech patterns according to claim 11, wherein said inputted unwanted and desired speech patterns are stored in one or more digital memory libraries.

15. The method for modifying speech patterns according to claim 11, wherein said step of actively detecting incoming speech patterns, comparing said detected incoming speech patterns with said unwanted speech patterns stored in said digital memory of unwanted speech patterns such that the unwanted speech patterns found in said incoming speech patterns are removed and queued for replacement, includes actively detecting incoming speech patterns, comparing said detected incoming speech patterns with said unwanted speech patterns stored in said digital memory of unwanted speech patterns such that the unwanted speech patterns found in said incoming speech patterns are removed and queued for replacement in real time.

16. The method for modifying speech patterns according to claim 11, wherein said step analyzing said unwanted speech patterns in incoming speech patterns and determining positively corresponding desired speech patterns includes analyzing said unwanted speech patterns in incoming speech patterns and determining positively corresponding desired speech patterns in real time.

17. The method for modifying speech patterns according to claim 11, wherein said step of replacing said unwanted speech patterns found in said incoming speech patterns with said desired speech patterns which are determined to be positively corresponding to said unwanted speech patterns includes replacing said unwanted speech patterns found in said incoming speech patterns with said desired speech patterns which are determined to be positively corresponding to said unwanted speech patterns in real time, thereby producing an output speech pattern in which said unwanted speech patterns have been removed and replaced with said desired speech patterns.

18. The method for modifying speech patterns according to claim 11, wherein said system is used for teaching desired speech patterns by modifying inputted unwanted speech patterns and outputting desired speech patterns in real time.

19. The method for modifying speech patterns according to claim 11, wherein said system is used to analyze unwanted speech patterns to detect and determine languages, dialects and accents.

20. The method for modifying speech patterns according to claim 11, wherein said system is used to analyze desired speech patterns to detect and determine languages, dialects and accents.
